(19) United States
(12) Patent Application Publication
(10) Pub. No.: US 2010/0021111 A1
(43) Pub. Date: Jan. 28, 2010

(54) OPTICAL FIBER CONNECTOR AND OPTICAL FIBER CONNECTOR ASSEMBLY

(76) Inventors: Wen-Ping Yu, Chung Ho City (TW); Tung-Po Chiu, Chung Ho City (TW)

Correspondence Address: PATTERSON & SHERIDAN, LLP - - - IPTEC, 3040 Post Oak Boulevard, Suite 1500, Houston, TX, 77056-6582, US

(21) Appl. No.: 12/467,714

(22) Filed: May 18, 2009

(30) Foreign Application Priority Data
Jul. 25, 2008 (TW) 097128241

(51) Int. Cl. G02B 6/36

(52) U.S. Cl. 385/83

(57) ABSTRACT

The present invention provides an optical fiber connector. The optical fiber connector is used for detachably engaging to a receptacle or a repeater. The optical fiber connector comprises a plug and an optical fiber module. The plug has a first end and a second end. The optical fiber module is disposed in the plug. The optical fiber module comprises three optical fibers. The three optical fibers are separately disposed from the first end and centralizedly extended out of the second end.

### BACKGROUND OF THE INVENTION

1. Field of the Invention

The present invention relates to an optical fiber connector and an optical fiber connector assembly, and more particularly, to an optical fiber connector and an optical fiber connector assembly which have three optical fibers. The optical fiber connector and the optical fiber connector assembly have the features of easy operation and large flexibility.

2. Description of the Prior Art

Optical fiber connectors are an essential part of the application of optical fiber based communication systems. For example, such connectors can be used to join segments of fibers into longer lengths, to connect fibers to active devices such as transceivers, detectors and repeaters, or to connect fibers to passive devices such as switches or attenuators. The central function of an optical fiber connector is to maintain or position two optical fiber ends such that the core of one optical fiber is axially aligned with the core of the other optical fiber. Besides, another central function of the optical fiber connector is to align the light emitted from a light emitter with an optical fiber. Consequently, the light from one fiber can be coupled to the other fiber or transferred between the fibers as efficiently as possible. It's a particularly challenging task because the light-carrying region (i.e. the core) of an optical fiber is quite small. In single-mode optical fibers, the core diameter is about 9 microns. In multi-mode optical fibers, the core diameter can be as large as 62.5 to 100 microns. Hence, the precise alignment is still a necessary feature to effectively interconnect the optical fibers.

Another function of the optical fiber connector is to provide mechanical stability and protection for the optical junction in its working environment. Generally, stability and junction protection is a key function of connector design (e.g., minimization of the different thermal expansion and mechanical movement effects). The precise alignment of the optical fiber is typically accomplished within the design of the optical terminus assembly. The typical optical terminus assembly utilizes a method of retention of the terminus within the connector(s) integrated within it and a method of holding and aligning the optical fiber. To align the optical fiber, a terminus typically includes a small cylinder of metal or ceramic at one end, commonly referred to as a “ferrule.” The ferrule has a high precision hole passing along its central line and glass which enables the plastic optical fiber to be installed into the hole within the ferrule by using mechanical, adhesive or other retention methods.

In the connection between a pair of optical fibers, a pair of ferrules is butted together in an end to end manner so that light can travel from one end to the other end along their common central axis. In this conventional optical connection, it is highly desirable for the cores of the glass fibers to be precisely aligned in order to minimize the loss of light (such loss being referred to as insertion loss) caused by the connection. However, it is known that to make a perfect connection is impossible presently. Manufacturing tolerances may approach “zero”, but practical consideration factor such as cost induces the fact that slight misalignment is tolerable; in other words, it is suggested that the perfection is unnecessary although stability across the operating environment of the fiber joint is critical.

Historically, due to manufacturing costs and design features, optical termini have tended to be manufactured as an assembly of loose components. In high performance connectors intended for single-mode application, there is a specific need to tune out the eccentricity of assemblies. Such tuning can be achieved by the interaction between the terminus or ferrule support structure and the connector housing. However, it is an undesirable effect as the housing becomes an integral element in tuning, and if the terminus is removed from the housing (such as for cleaning or replacement), the tuning is in effect lost.

Optical terminus assembly tuning is used to reduce the random position of the optical fiber within an optical connector. The randomness of this positioning may be in the order of fractions of microns to several microns. However, when the consideration of single-mode optical fiber with an optical waveguide of 8-9 microns in diameter is taken, it can be seen how optical insertion loss can be dramatically impacted if the control of the placement of the optical core is not maintained. Thus, fiber eccentricity compensation is currently most commonly found on single channel “LC” type connectors. Compensation is attained using a faceted structure (such as a square or hexagon) to register on the front end of the ferrule support structure. The ferrule support structure may engage an appropriate complementary pattern within the LC connector body and retains positioning by engaging the LC body. Therefore, tuning or fiber eccentricity compensation is only retained as the ferrule and its support are retained within the connector body. Once being removed, it is impossible to determine the exact positional relationship between the optical fiber holding structure and the connector body.

Hence, after recognizing the engineering challenge posed by the alignment of two very small optical fiber cores, an aspect of the invention is to provide an optical fiber connector and optical fiber connector assembly that the optical fibers therein can operate without being precisely aligned and make the cost inexpensive by providing a more simplified structure. The optical fiber connector and the optical fiber connector assembly of the invention mainly transmit the optical signals via three optical fibers (for example, the optical signals emitted from light emitters). In addition, the optical fiber connector and the optical fiber connector assembly of the invention feature have the advantages of easy operation, large flexibility, and convenience for customers to manipulate.

### SUMMARY OF THE INVENTION

An aspect of the present invention is to provide an optical fiber connector. The optical fiber connector can be used for detachably engaging to a receptacle or a repeater. The optical fiber connector includes a plug and an optical fiber module. The plug has a first end and a second end. The optical fiber module is disposed in the plug. The optical fiber module includes three optical fibers which are separately disposed from the first end and centralizedly extended out of the second end.

Another aspect of the present invention is to provide an optical fiber connector assembly. The optical fiber connector assembly includes an optical fiber connector and a repeater. The optical fiber connector includes a plug and a first optical fiber module. The plug has a first end and a second end. The first optical fiber module is disposed in the plug. The first optical fiber module includes three first optical fibers which are separately disposed from the first end and centralizedly extended out of the second end. The first end of the plug is detachably engaged to the repeater. The repeater includes three recesses. Each of the recesses corresponds to one first optical fiber respectively. When the first end of the plug is connected to the repeater, each of the first optical fibers is respectively accommodated to one corresponding recess of the recesses.

Another aspect of the present invention is to provide an optical fiber connector assembly. The optical fiber connector assembly includes an optical fiber connector and a receptacle. The optical fiber connector includes a plug and an optical fiber module. The plug has a first end and a second end. The optical fiber module is disposed in the plug. The optical fiber module includes three optical fibers which are separately disposed from the first end and centralizedly extended out of the second end. The first end of the plug is detachably engaged to the repeater. The repeater includes three recesses. Each of the recesses corresponds to one first optical fiber respectively. When the first end of the plug is connected to the receptacle, each of the optical fibers is respectively accommodated to one corresponding recess of the recesses.

According to the optical fiber connector and the optical fiber connector assembly of the invention, the optical fibers therein can operate without being precisely aligned and make the cost inexpensive by providing a more simplified structure. The optical fiber connector and the optical fiber connector assembly of the invention mainly transmit the optical signals via three optical fibers (for example, the optical signals emitted from light emitters). In addition, the optical fiber connector and the optical fiber connector assembly of the invention feature ease to use, large flexibility usage, and convenience for customers to manipulate.

The objective of the present invention will no doubt become obvious to those of ordinary skill in the art after reading the following detailed description of the preferred embodiment, which is illustrated in following figures and drawings.

### BRIEF DESCRIPTION OF THE APPENDED DRAWINGS

FIG. 1A is an appearance drawing illustrating an optical fiber connector according to an embodiment of the invention.

FIG. 1B is a top view illustrating the optical fiber connector in FIG. 1A.

FIG. 2 is a schematic diagram illustrating an optical fiber connector assembly according to a first preferred embodiment of the invention, wherein the plug of the optical fiber connector is plugged in a receptacle, and the receptacle is shown in a cross-sectional view.

FIG. 3 is a schematic diagram illustrating an optical fiber connector assembly according to a second preferred embodiment of the invention, wherein the plug of the optical fiber connector is plugged in a repeater, and the repeater is shown in a cross-sectional view.

FIG. 4 is a schematic diagram illustrating a repeater applied for the optical fiber connector according to another preferred embodiment of the invention, wherein the plug of the optical fiber connector is plugged in the repeater, and the repeater is shown in a cross-sectional view.

### DETAILED DESCRIPTION OF THE INVENTION

An aspect of the present invention is to provide an optical fiber connector and an optical fiber connector assembly. The optical fibers therein can operate without being precisely aligned and make the cost inexpensive by providing a more simplified structure. The following will describe in detail a preferred embodiment of the invention, so as to illustrate the characteristic, the spirit, the advantage and the simplification in practice of the invention.

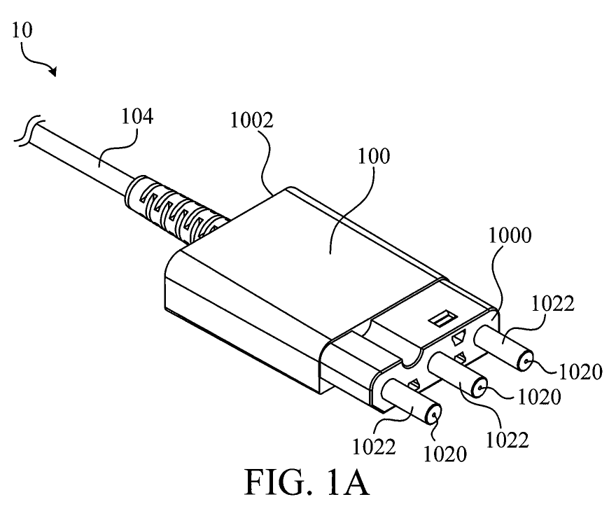

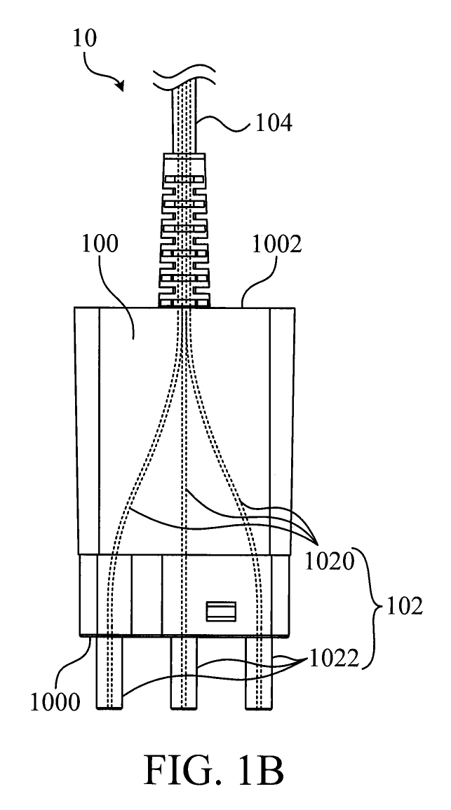

Please refer to FIG. 1A and FIG. 1B. FIG. 1A is an appearance drawing illustrating an optical fiber connector 10 according to an embodiment of the invention. FIG. 1B is a top view illustrating the optical fiber connector 10 in FIG. 1A. As shown in FIG. 1B, the optical fiber connector 10 according to the preferred embodiment of the invention includes a plug 100 and an optical fiber module 102. The plug 100 has a first end 1000 and a second end 1002. The optical fiber module 102 is disposed in the plug 100. Furthermore, the optical fiber module 102 includes three optical fibers 1020. The three optical fibers 1020 are separately disposed from the first end 1000 of the plug 100 and centralizedly extended out of the second end 1002 of the plug 100. The three optical fibers 1020 extending from the second end 1002 of the plug 100 can be wrapped by a cable sheath 104. The cable sheath 104 can be made of, but not limited to, non-conducting and opaque plastic materials. The optical fiber connector 10 of the preferred embodiment will be introduced and described in detail below.

As shown in FIG. 1B, the optical fiber module 102 can further include three ferrules 1022. The three ferrules 1022 are disposed on the first end 1000 of the plug 100. In addition, each of the ferrules 1022 wraps and clips one corresponding optical fiber of the three optical fibers 1020. In an embodiment, the forgoing three ferrules 1022 can be made of, but not limited to, plastic materials or ceramic materials.

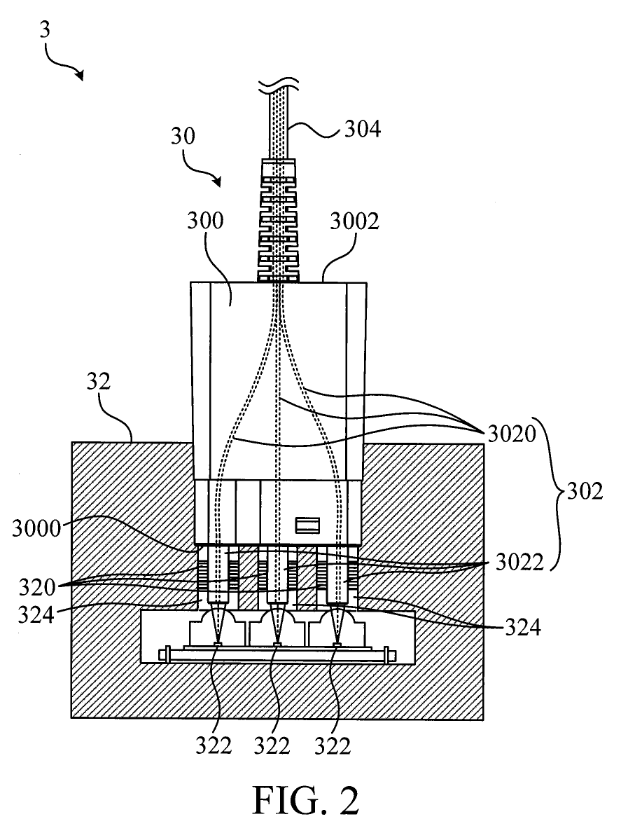

Please refer to FIG. 2. FIG. 2 is a schematic diagram illustrating an optical fiber connector assembly 3 according to a first preferred embodiment of the invention, wherein the plug 300 of the optical fiber connector 30 is plugged in a receptacle 32, and the receptacle 32 is shown in a cross-sectional view. As shown in FIG. 2, the optical fiber connector 30 in the optical fiber connector assembly 3 according to the first preferred embodiment of the invention can be detachably engaged to the receptacle 32. The optical fiber connector 30 mainly includes a plug 300 and an optical fiber module 302. The plug 300 has a first end 3000 and a second end 3002, and the first end 3000 of the plug 300 can be accommodated in the receptacle 32, as shown in FIG. 2. The foregoing optical fiber module 302 is disposed in the plug 300. Furthermore, the optical fiber module 302 includes three optical fibers 3020. The three optical fibers 3020 are separately disposed from the first end 3000 of the plug 300 and centralizedly extended out of the second end 3002 of the plug 300. Similarly, the three optical fibers 3020 extending from the second end 3002 of the plug 300 can be wrapped by a cable sheath 304. The cable sheath 304 can be made of, but not limited to, non-conducting and opaque plastic materials. The optical fiber connector 30 of the preferred embodiment will be introduced and described in detail below.

As shown in FIG. 2, the optical fiber module 302 can further include three ferrules 3022. The ferrules 3022 are disposed on the first end 3000 of the plug 300. In addition, each of the ferrules 3022 wraps and clips one corresponding optical fiber of the optical fibers 3020. In an embodiment, the foregoing three ferrules 3022 are made of, but not limited to, plastic materials or ceramic materials.

In order to appropriately and correctly connecting the optical fiber connector 30 with the receptacle 32 when the optical fiber connector 30 is plugged into the receptacle 32, the receptacle 32 can further include three recesses 324 corresponding to the foregoing three ferrules 3022, as shown in FIG. 2. The profiles of the three recesses 324 are adapted to accommodate the three ferrules 3022. Thereby, each of the ferrules 3022 can be accommodated in one corresponding recess 324 of the three recesses 324 respectively when the first end 3000 of the plug 300 is engaged to the receptacle 32. It is notable that the ferrules 3022 and the corresponding recesses 324 are not limited to be tight fit or loose fit, and it is fine as long as achieving the goal of letting the recesses 324 accommodate the ferrules 3022.

As shown in FIG. 2, the ferrules 3022 and the corresponding recesses 324 in the preferred embodiment are loose fit. The receptacle 32 can further include three retaining members 320. Each of the retaining members 320 is disposed in a corresponding recess 324 of the three recesses 324 respectively. Each of the retaining members 320 clamps one corresponding ferrule 3022 of the three ferrules 3022 respectively after the first end 3000 of the plug 300 is engaged to the receptacle 32. For example, each of the retaining members 320 can be a C-type ring, and the three retaining members 320 can be made of, but not limited to, metal materials or ceramic materials. Thereby, when the first end 3000 of the plug 300 of the optical fiber connector 30 is plugged into the receptacle 32, each of the ferrules 3022 on the first end 3000 can press one corresponding C-type ring outward and be fixedly clamped by the corresponding C-type ring.

In the preferred embodiment, the receptacle 32 can further include three light emitters 322. The three light emitters 322 are disposed in the receptacle 32, and each of the light emitters 322 can emit a light by driven. When the first end 3000 of the plug 300 of the optical fiber connector 30 of the optical fiber connector assembly 3 according to the invention is engaged to the receptacle 32, each of the optical fibers 3020 can be coupled to the light emitted from one corresponding light emitter 322 of the light emitters 322 respectively. In other words, the function of the foregoing receptacle 32 is similar to that of a transmitter optical subassembly (TOSA).

For example, the other end of the optical fiber connector 30 of the optical fiber connector assembly 3 according to the first preferred embodiment of the invention can be another plug (not shown) which has the same structure as the plug 300, whose interior structure will not be redundantly described here. It is notable that the another plug of the optical fiber connector 30 also can be engaged to another receptacle (not shown). In addition, the another receptacle can include three photodetectors (not shown). Thereby, after the two ends of the optical fiber connector 30 according to the invention are engaged to their corresponding receptacles, the light transmitted from the optical module 302 can be received by the corresponding photodetectors respectively. In other words, the function of the another receptacle is similar to that of a receiver optical subassembly (ROSA). For example, if the distance between a TOSA and a ROSA is not too long, the optical fiber connector 30 (whose two ends are both plugs) can be used to couple to the TOSA and the ROSA respectively when the light emitted from the TOSA is transmitted to the ROSA.

In practice application, the three optical fiber 3020 of the foregoing optical fiber connector 30 according to the invention can, but is not limited to, assign two optical fibers for a TOSA to transmit lights (which may include video signals) to a ROSA and assign the last one optical fiber for the ROSA to feedback the lights (which may include a control signal) to the TOSA. It can be determined based on the purpose expected to be achieved in actual applications.

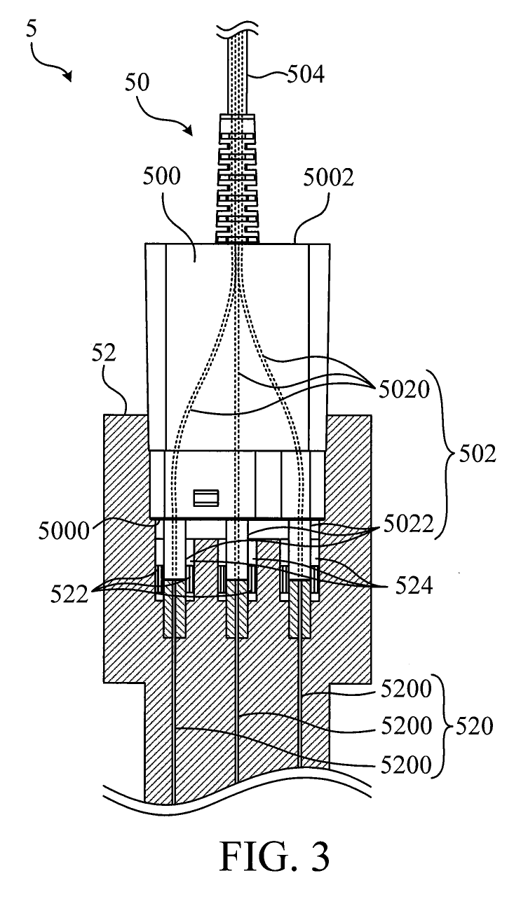

Please refer to FIG. 3. FIG. 3 is a schematic diagram illustrating an optical fiber connector assembly 5 according to a second preferred embodiment of the invention, wherein the plug 500 of the optical fiber connector 50 is plugged in a repeater 52, and the repeater 52 is shown in a cross-sectional view. As shown in FIG. 3, the optical fiber connector 50 according to the second preferred embodiment of the invention mainly includes a plug 500 and a repeater 52. The plug 500 has a first end 5000 and a second end 5002. The plug includes a first optical fiber module 502. Furthermore, the first optical fiber module 502 includes three first optical fibers 5020. The three first optical fibers 5020 are separately disposed from the first end 5000 of the plug 500 and centralizedly extended out of the second end 5002 of the plug 500. The first end 5000 of the plug 500 is detachably engaged to the repeater 52. The repeater 52 includes a second optical fiber module 520. The second optical fiber module 520 includes three second optical fibers 5200. Each of the second optical fibers 5200 can be coupled to one of the first optical fibers 5020 respectively when the first end 5000 of the plug 500 is engaged to the repeater 52. Similarly, the three first optical fibers 5020 extending from the second end 5002 of the plug 500 can be wrapped by a cable sheath 504. The cable sheath 504 can be made of, but not limited to, non-conducting and opaque plastic materials. The optical fiber connector 50 of the preferred embodiment will be introduced and described in detail below.

Similarly, the first optical fiber module 502 can further include three ferrules 5022, as shown in FIG. 3. The three ferrules 5022 are disposed on the first end 5000 of the plug 500. In addition, each of the ferrules 5022 wraps and clips one corresponding first optical fiber 5020 of the three first optical fibers 5020. In an embodiment, the foregoing three ferrules 5022 can be made of, but not limited to, plastic materials or ceramic materials.

Moreover, in order to appropriately and correctly connecting the optical fiber connector 50 with the repeater 52 when the optical fiber connector 50 is plugged into the repeater 52, the repeater 52 can further include three recesses 524 corresponding to the three ferrules 5022, as shown in FIG. 3. The profiles of the three recesses 524 are adapted to accommodate the three ferrules 5022. Thereby, each of the ferrules 5022 can be accommodated in one corresponding recess 524 of the three recesses 524 respectively when the first end 5000 of the plug 500 is engaged to the repeater 52. It is notable that the ferrules 5022 and the corresponding recesses 524 are not limited to be tight fit or loose fit, and it is fine as long as achieving the goal of letting the recesses 524 accommodate the ferrules 5022.

As shown in FIG. 3, the ferrules 5022 and their corresponding recesses 524 in the preferred embodiment are loose fit. The repeater 52 can further include three retaining members 522. Each of the retaining members 522 is disposed in a corresponding recess 524 of the three recesses 524 respectively. Each of the retaining members 522 clamps one corresponding ferrule 5022 of the three ferrules 5022 respectively after the first end 5000 of the plug 500 is engaged to the repeater 52. Similarly, each of the retaining members 522 can be a C-type ring, and the three retaining members 522 can be made of, but not limited to, metal materials or ceramic materials. Thereby, when the first end 5000 of the plug 500 of the optical fiber connector 50 is plugged into the repeater 52, each of the ferrules 5022 on the first end 5000 can press one corresponding C-type ring outward and be fixedly clamped by the corresponding C-type ring.

For example, the other end along the cable sheath 504 of the optical fiber connector 50 of the optical fiber connector assembly 5 according to the second preferred embodiment of the invention can be another plug (not shown) which has the same structure as the plug 500. Thereby, the another plug can be selectively engaged to the receptacle (for example, a TOSA or a ROSA) or another repeater.

In addition, the structure of the foregoing repeater 52 can also be symmetric (not shown in FIG. 3). In other words, both two ends of the repeater 52 are capable of being engaged to the plug 500 of the optical fiber connector 50. For example, if the distance between a TOSA and a ROSA is too large, a plurality of the optical fiber connector assemblies 5 (i.e. a combination of optical fiber connectors 50 and repeaters 52) can be used to extend the total length of optical fibers and to couple to the TOSA and the ROSA respectively when the light emitted from the TOSA is transmitted to the ROSA.

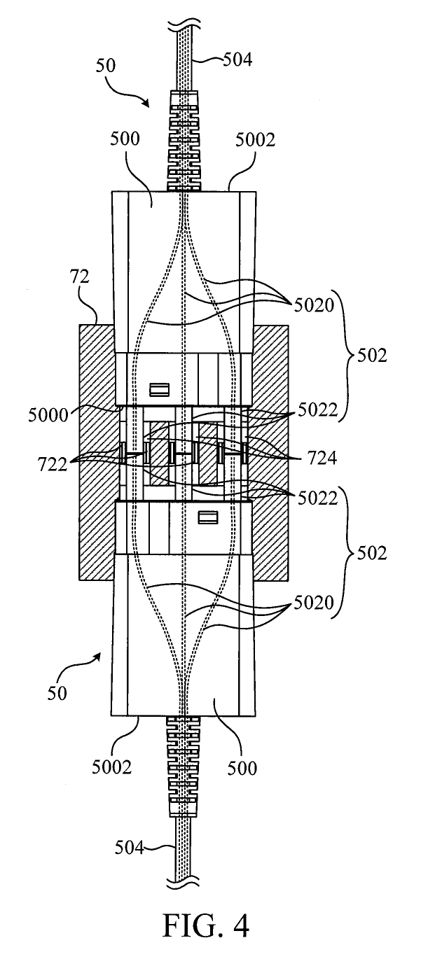

Please refer to FIG. 4. FIG. 4 is a schematic diagram illustrating a repeater applied for the optical fiber connector 50 according to another preferred embodiment of the invention, wherein the plug 500 of the optical fiber connector 50 is plugged in the repeater 72, and the repeater 72 is shown in a cross-sectional view. As shown in FIG. 4, the repeater 72 in the embodiment has symmetric two ends which can provide for two similar plugs 500 of optical fiber connectors 50 to plug into. The interior structures and functions of the two optical fiber connectors 50 are all the same as those of the first preferred embodiment and the second preferred embodiment of the invention, and they will not be redundantly described here. It is notable that the repeater 72 of the embodiment has three recesses 724 which pass through two ends of the repeater 72. The profiles of the three recesses 724 are adapted to accommodate the ferrules 5022 of the two optical fiber connectors 50 respectively. Thereby, when the first ends 5000 of the plugs 500 of the two optical fiber connectors 50 are engaged to the repeater 72 via the two ends of the repeater 72 respectively, each of the ferrules 5022 can be accommodated in a corresponding recess 724 of the three recesses 724 respectively, so as to make each of the first optical fibers 5020 in the ferrules 5022 of one optical fiber connector 50 be coupled with the first optical fibers 5020 in the ferrules 5022 of another optical fiber connector 50.

Moreover, the repeater 72 can further include three retaining members 722. Each of the retaining members 722 is disposed in a corresponding recess 724 of the three recesses 724. Each of the retaining members 722 simultaneously clamps two ferrules 5022 of the two optical fiber connectors 50 to accommodate in a corresponding recess 724 respectively after the first ends 5000 of the plugs 500 of the two optical fiber connectors 50 are engaged to the repeater 72. Thereby, the optical fibers 5020 of the two optical fiber modules 502 of the two optical fiber connectors 50 can be coupled to each other one by one when the first ends 5000 of the plugs 500 of said the foregoing two optical fiber connectors 50 are engaged to the repeater 72 via two ends of the repeater 72 respectively. Accordingly, the repeater 72 of the preferred embodiment does not include any optical fiber and retains the ferrules 5022 of the plugged two optical fiber connectors 50 to be corresponded to each other via the three recesses 724 or the retaining members 722, so as to make the first optical fibers 5020 in the ferrules 5022 at two ends be coupled to each other and transmit signals.

It can be obviously seen based on above detailed description about the preferred embodiment of the invention that according to the optical fiber connector and the optical fiber connector assembly of the invention, the optical fibers therein can operate without being precisely aligned and make the cost inexpensive by providing a more simplified structure. The optical fiber connector and the optical fiber connector assembly of the invention mainly transmit the optical signals via three optical fibers (for example, the optical signals emitted from light emitters). In addition, the optical fiber connector and the optical fiber connector assembly of the invention feature ease to use, large flexibility usage, and convenience for customers to manipulate.

Although the present invention has been illustrated and described with reference to the preferred embodiment thereof, it should be understood that it is in no way limited to the details of such embodiment but is capable of numerous modifications within the scope of the appended claims.

What is claimed is:

1. An optical fiber connector for detachably engaging to a receptacle or a repeater, the optical fiber connector comprising:
a plug having a first end and a second end; and
an optical fiber module, disposed in the plug, the optical fiber module comprising three optical fibers which are separately disposed from the first end and centralizedly extended out of the second end.

2. The optical fiber connector of claim 1, wherein the optical fiber module further comprises three ferrules, disposed on the first end of the plug, each of the ferrules wraps and clips one corresponding optical fiber of the optical fibers.

3. The optical fiber connector of claim 2, wherein the ferrules are made of plastic material or ceramic material.

4. The optical fiber connector of claim 2, wherein the receptacle further comprises three recesses which each corresponds to one of the ferrules, each of the ferrules is accommodated in one corresponding recess of the recesses respectively when the first end of the plug is engaged to the receptacle.

5. The optical fiber connector of claim 4, wherein the receptacle further comprises three retaining members, each of the retaining members is disposed in one corresponding recess of the recesses respectively, and each of the retaining members clamps one corresponding ferrule of the ferrules respectively after the first end of the plug is engaged to the receptacle.

6. The optical fiber connector of claim 5, wherein each of the retaining members is a C-type ring.

7. The optical fiber connector of claim 5, wherein the retaining members are made of metal material or ceramic material.

8. The optical fiber connector of claim 1, wherein the repeater further comprises three recesses which each corresponds to one of the optical fibers respectively; each of the optical fibers is accommodated to one corresponding recess of the recesses when the first end of the plug is engaged to the repeater.

9. An optical fiber connector assembly comprising:
an optical fiber connector comprising:
a plug having a first end and a second end; and
a first optical fiber module, disposed in the plug; the first optical fiber module comprising three first optical fibers which are separately disposed from the first end and centralizedly extended out of the second end; and
a repeater, the first end of the plug detachably being engaged to the repeater, the repeater comprising three recesses which each corresponds to one of the first optical fibers respectively, each of the first optical fibers being accommodated in one corresponding recess of the recesses respectively when the first end of the plug is engaged to the repeater.

10. The optical fiber connector assembly of claim 9, wherein the first optical fiber module further comprises three ferrules, disposed on the first end of the plug, each of the ferrules wraps and clips one corresponding optical fiber of the optical fibers respectively, each of the ferrules corresponds to one of the recesses respectively, each of the ferrules is accommodated to one corresponding recess of the recesses respectively when the first end of the plug is engaged to the repeater.

11. The optical fiber connector assembly of claim 10, wherein the repeater further comprises three retaining members, each of the retaining members is disposed in one corresponding recess of the recesses respectively, and each of the retaining members clamps one corresponding ferrule of the ferrules respectively after the first end of the plug is connected to the repeater.

12. The optical fiber connector assembly of claim 11, wherein each of the retaining members is a C-type ring.

13. The optical fiber connector assembly of claim 10, wherein the recesses pass through the two ends of the repeater, the first end of the plug of the optical fiber connector assembly is capable of being selectively inserted into the recesses through any end of the repeater, and each of the first optical fibers is capable of being accommodated to the corresponding recesses respectively through any end of the repeater.

14. The optical fiber connector assembly of claim 13, wherein the repeater further comprises three retaining members, each of the retaining members is disposed respectively in one corresponding recess of the recesses, after two first ends of two plugs of two equivalent optical fiber connectors are engaged to the repeater respectively via two ends of the repeater, each of the retaining members respectively clamps two ferrules, accommodated to one corresponding recess of the recesses, of the equivalent optical fiber connectors simultaneously.

15. The optical fiber connector assembly of claim 9, wherein the repeater further comprises a second optical fiber module, the second optical fiber module comprises three second optical fibers, each of the second optical fibers is coupled to one of the first optical fibers respectively when the first end of the plug is engaged to the repeater.

16. An optical fiber connector assembly comprising:
an optical fiber connector comprising:
a plug having a first end and a second end; and
an optical fiber module, disposed in the plug, comprising three first optical fibers which are separately disposed from the first end and centralizedly extended out of the second end; and
a receptacle, the first end of the plug being detachably engaged to the receptacle, the receptacle comprising three recesses which each corresponds to one of the three optical fibers respectively, each of the optical fibers being accommodated in one corresponding recess of the recesses respectively when the first end of the plug is engaged to the receptacle.

17. The optical fiber connector assembly of claim 16, wherein the optical fiber module further comprises three ferrules, disposed on the first end of the plug, each of the three ferrules wraps and clips one corresponding optical fiber of the optical fibers respectively, the ferrules correspond to the recesses respectively, each of the ferrules is accommodated to one corresponding recess of the recesses respectively when the first end of the plug is engaged to the receptacle.

18. The optical fiber connector assembly of claim 17, wherein the receptacle further comprises three retaining members, each of the retaining members are disposed in one corresponding recess of the recesses respectively, and each of the retaining members clamps one corresponding ferrule of the ferrules respectively after the first end of the plug is connected to the receptacle.

19. The optical fiber connector assembly of claim 18, wherein each of the retaining members is a C-type ring.

20. The optical fiber connector assembly of claim 16, wherein the receptacle further comprises three optical emitters, disposed in the receptacle, each of the optical emitters is driven to emit a light, each of the optical fibers is coupled to the light emitted by one corresponding optical emitter of the optical emitters respectively when the first end of the plug is engaged to the receptacle.
